(19) United States
(12) Patent Application Publication
(10) Pub. No.: US 2025/0016480 A1
(43) Pub. Date: Jan. 9, 2025

(54) OPTICAL TRANSMISSION DEVICE

(71) Applicant: NIPPON TELEGRAPH AND TELEPHONE CORPORATION, Tokyo (JP)

(72) Inventors: Naotaka SHIBATA, Musashino-shi (JP); Shin KANEKO, Musashino-shi (JP); Takuya KANAI, Musashino-shi (JP); Tomoaki YOSHIDA, Musashino-shi (JP)

(73) Assignee: NIPPON TELEGRAPH AND TELEPHONE CORPORATION, Tokyo (JP)

(21) Appl. No.: 18/709,995

(22) PCT Filed: Nov. 19, 2021
(86) PCT No.: PCT/JP2021/042544

§ 371 Date: May 14, 2024

(51) Int. Cl. H04Q 11/00

(52) U.S. Cl. CPC H04Q 11/0005; H04Q 2011/0016; H04Q 2011/0041

(57) ABSTRACT

An aspect of the present invention is an optical transmission device including a connector that is able to be connected to an accommodation module accommodating an optical fiber such that optical communication is performed, an optical switch that receives an optical signal from the connector and outputs an optical signal to the connector, an optical switch controller that controls the optical switch, an up wavelength multiplexer/demultiplexer that multiplexes light of a plurality of wavelengths output from the optical switch and outputs the multiplexed light to a transmission line, and a down wavelength multiplexer/demultiplexer that demultiplexes light input from the transmission line and outputs the demultiplexed light to the optical switch, wherein the connector can be connected to any one of a one-core accommodation module and a two-core accommodation module as the accommodation module.

### TECHNICAL FIELD

The present invention relates to technology of an optical transmission device.

### BACKGROUND ART

An optical communication device capable of relaying an optical signal depending on a destination while reducing delay has been proposed (refer to Patent Literature 1, for example). An example of a configuration shown in FIG. 8 will be described as a configuration of an optical communication device related to Patent Literature 1.

FIG. 8 illustrates an optical switch (optical SW), a wavelength management controller, an optical SW controller, and up and down wavelength multiplexers/demultiplexers. The optical switch outputs each of input optical signals from one or more subscriber devices to a transmission line of any one route. The wavelength management controller dynamically allocates wavelengths used by subscriber devices. The optical SW controller controls the optical switch such that optical signals of the subscriber devices are transmitted to transmission lines of desired routes. The wavelength multiplexers/demultiplexers multiplex a plurality of wavelengths or demultiplex a wavelength into a plurality of wavelengths.

Further, the subscriber device shown in FIG. 8 has an optical transceiver. The optical transceiver may be a wavelength variable optical transceiver, and in this case, communication can be performed at an arbitrary wavelength. Further, the optical transceiver may be an optical transceiver with an auxiliary management and control channel (AMCC) function, and in this case, a utilization wavelength can be controlled through a control signal superimposed by the AMCC. In a case where the wavelength management controller performs control, the optical SW controller changes wiring of the optical SW such that the subscriber device and the wavelength management controller are connected.

Regarding the number of optical fibers, up and down fibers are separated from each other and the same wavelength is often used in relay, and thus in the configuration example of FIG. 8, the wavelength multiplexers/demultiplexers are divided into up and down wavelength multiplexers/demultiplexers, and thus the number of optical fibers corresponds thereto. In addition, in an access period, one core is used in many cases with up and down as separate wavelengths. In this case, it is necessary to convert an optical signal from a one-core subscriber device into a two-core optical signal. Although an optical signal transmitted from the subscriber device through a one-core optical fiber is converted into a two-core optical signal through a WDM filter in the configuration example of FIG. 8, the mode of connection from the subscriber device is not limited only to the one-core optical fiber, and as shown in FIG. 8, a subscriber device using a two-core transceiver may also be accommodated.

In the configuration example of FIG. 8, a subscriber device first sends a control signal to the wavelength management controller, and the wavelength management controller notifies of a wavelength to be used. At this time, an up port can be identified by presence or absence of optical power according to the control signal, but a down port corresponding to the subscriber device cannot be discovered without prior information. For this reason, it is necessary to determine in advance a down port to be located for an up port of a certain subscriber device.

### CITATION LIST

### Patent Literature

Patent Literature 1: PCT International Publication No. WO 2021/131202

### SUMMARY OF INVENTION

### Technical Problem

As shown in the configuration example of FIG. 8, in a case where the subscriber device is one core, it is necessary to install a WDM filter, and an operation of wiring between the optical switch and the WDM filter occurs. As described above, since the content of a local operation is different for each subscriber device in the configuration example of FIG. 8, a local operator is likely to be confused. Further, in addition to installation of the WDM filter and selection of a rack therefor, an inter-rack wiring operation occurs depending on the installation place of the optical switch.

Further, in a case where an optical switch, a WDM filter, and the like are installed once in a construction work process and it is found in a subsequent opening process that, contrary to previous information, a subscriber device is actually two cores, for example, it is necessary to remove all of the installed WDM filter and optical fiber. In this way, in the configuration example of FIG. 8, it is not possible to flexibly cope with the case of a change of one core to two cores.

Furthermore, up and down for one subscriber device need to be inserted into predetermined ports, but in the configuration example of FIG. 8, up and down are selected from a plurality of ports (all ports of the optical switch) and thus a wiring error can occur.

As described above, since the content of an operation depends on the subscriber device in the conventional technology, installation of a WDM filter is required and a wiring operation occurs, and thus operations cannot be simplified.

In view of the foregoing circumstances, an object of the present invention is to provide a technology capable of simplifying an operation.

### Solution to Problem

One aspect of the present invention is an optical transmission device including: a connector that is able to be connected to an accommodation module accommodating an optical fiber such that optical communication is performed; an optical switch that receives an optical signal from the connector and outputs an optical signal to the connector; an optical switch controller that controls the optical switch; an up wavelength multiplexer/demultiplexer that multiplexes light of a plurality of wavelengths output from the optical switch and outputs the multiplexed light to a transmission line; and a down wavelength multiplexer/demultiplexer that demultiplexes light input from the transmission line and outputs the demultiplexed light to the optical switch, wherein the connector is able to be connected to any one of a one-core accommodation module and a two-core accommodation module as the accommodation module.

### Advantageous Effects of Invention

According to the present invention, it is possible to simplify an operation.

### BRIEF DESCRIPTION OF DRAWINGS

FIG. 1 is a block diagram illustrating a configuration of an optical transmission system in a first embodiment.

FIG. 2 is a diagram illustrating a configuration example of a one-core accommodation module.

FIG. 3 is a diagram illustrating a configuration example of a two-core accommodation module.

FIG. 4 is a block diagram illustrating a configuration of an optical transmission system in a second embodiment.

FIG. 5 is a block diagram illustrating a configuration of an optical transmission system in a third embodiment.

FIG. 6 is a diagram illustrating a configuration example of a one-core accommodation module.

FIG. 7 is a diagram illustrating a configuration example of a two-core accommodation module.

FIG. 8 is a diagram showing an example of a conventional technology.

### DESCRIPTION OF EMBODIMENTS

Embodiments of the present invention will be described in detail with reference to the diagrams.

### First Embodiment

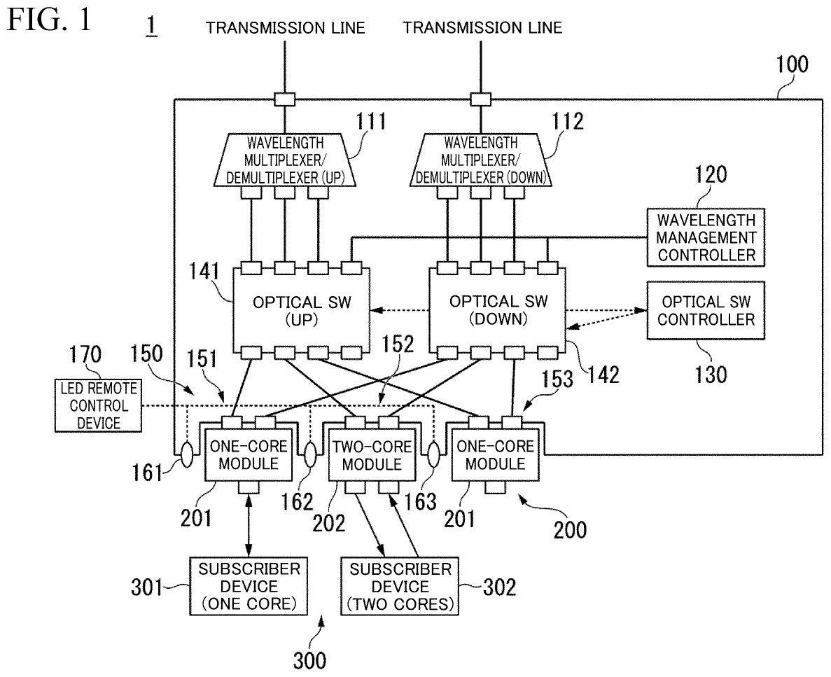

FIG. 1 is a block diagram illustrating a configuration of an optical transmission system 1 in a first embodiment. The optical transmission system 1 includes an optical transmission device 100, an accommodation module 200, and a subscriber device 300. Thereamong, the accommodation module 200 includes a one-core accommodation module 201 and a two-core accommodation module 202. Further, the subscriber device 300 includes a one-core subscriber device 301 and a two-core subscriber device 302. The one-core accommodation module 201 is a module connected to the one-core subscriber device 301 by an optical fiber. The two-core accommodation module 202 is a module connected to the two-core subscriber device 302 by an optical fiber.

The optical transmission device 100 includes an up wavelength multiplexer/demultiplexer 111, a down wavelength multiplexer/demultiplexer 112, an up optical SW (switch) 141, a down optical SW (switch) 142, a wavelength management controller 120, an optical SW (switch) controller 130, light emitting diode (LED) lamps 161, 162, and 163, and connectors 151, 152, and 153. In a case where the connectors 151, 152, and 153 are not distinguished from each other, the connectors 151, 152, and 153 are represented as a connector 150. Instead of separately providing up and down optical SWs (switches), one optical SW may accommodate up and down.

The wavelength management controller 120 dynamically allocates a wavelength used by the subscriber device 300. Specifically, the wavelength management controller 120 connects with the subscriber device 300 via the optical SW 141 or the optical SW 142 and dynamically allocates the wavelength used by the subscriber device 300 at the start of communication of the subscriber device 300. The optical SW controller 130 controls the optical SWs 130 such that an optical signal from the subscriber device 300 is transmitted to a transmission line of a desired route. The wavelength multiplexer/demultiplexer 111 multiplexes light with a plurality of wavelengths output from the optical SW 141 and outputs the multiplexed signal to a transmission line. The wavelength multiplexer/demultiplexer 112 demultiplexes light input from a transmission line and outputs the demultiplexed signals to the optical SW 142. The optical SW 141 switches a path of an optical signal from the subscriber device 300 according to control of the optical SW controller 130 and outputs the optical signal to the wavelength multiplexer/demultiplexer 111. The optical SW 142 switches a path of an optical signal from the wavelength multiplexer/demultiplexer 111 according to control of the optical SW controller 130 and outputs the optical signal to the subscriber device 300. Another device that monitors the entire network may determine a wavelength and a path to be used by each subscriber device 300 for communication and issue an instruction to the wavelength management controller 120 and the optical SW controller 130. In this case, the optical transmission device 100 is provided with a port for connection with the aforementioned other device.

The connector 150 can connect the accommodation module 200 to the optical transmission device 100 such that optical communication is performed. A plurality of connectors 150 (three connectors 151, 152, and 153 in the present embodiment) are provided in the optical transmission device 100. The connector 150 can connect both the one-core accommodation module 201 and the two-core accommodation module 202 to the optical transmission device 100 such that optical communication is performed. The connector 150 is, for example, a socket into/from which the accommodation module 200 can be inserted/removed.

Each connector 150 is provided with two ports. In the present embodiment, a port is a hole through which an optical fiber passes. One port is a port for an up optical fiber, and the other port is a port for a down optical fiber. An optical fiber that has passed through the port for the up optical fiber is connected to the optical SW 141. An optical fiber that has passed through the port for the down optical fiber is connected to the optical SW 142.

In the case of a device connected by one core such as a subscriber device 301, the one-core accommodation module 201 is connected to the connector 150. In the case of a device connected by two cores such as a subscriber device 302, the two-core accommodation module 202 is connected to the connector 150.

The LED lamps 161, 162, and 163 are provided to correspond to the connectors 151, 152, and 153, respectively. The LED lamps 161, 162, and 163 are examples of identification parts capable of identifying a connector 150 to which the accommodation module 200 for connecting an optical fiber has been connected. The LED lamps 161, 162, and 163 are connected to an LED remote control device 170. The LED remote control device 170 can remotely control states (on, off, flashing, and the like) of the LED lamps 161, 162, and 163. In a case where a plurality of accommodation modules 200 are connected to the optical transmission device 100 during an opening operation, the LED lamps 161, 162, and 163 identify which accommodation module 200 should be connected by an operation.

For example, the LED remote control device 170 turns on an LED corresponding to a connector 150 to which an accommodation module 200 for connecting an optical fiber through a remote operation has been connected. For example, in a case where an optical fiber is connected to the accommodation module 200 connected to the connector 151, the LED 161 is turned on. Accordingly, the operator can check the connection in front of the housing of the optical transmission device 100, and thus can perform an operation without any trouble in determining which accommodation module 200 should be connected.

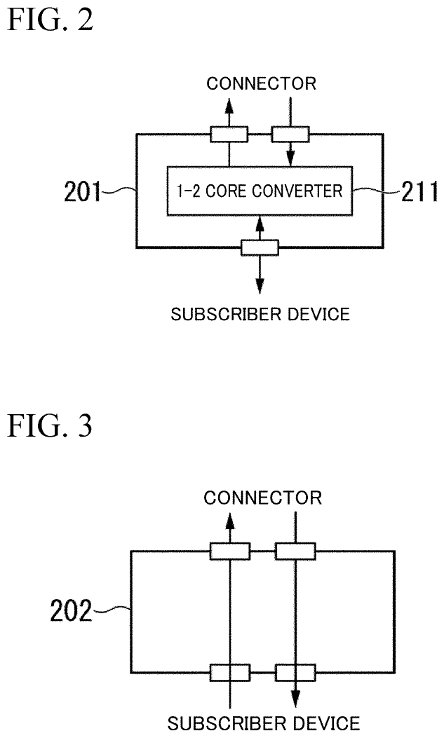

FIG. 2 is a diagram illustrating a configuration example of the one-core accommodation module 201. The one-core accommodation module 201 includes a 1-2 core converter 211. The 1-2 core converter 211 performs conversion from one core to two cores and from two cores to one core. The 1-2 core converter 211 is, for example, a WDM filter or a circulator. FIG. 3 is a diagram illustrating a configuration example of the two-core accommodation module 202. The two-core accommodation module 202 is simply a coupling part between the optical fiber from the subscriber device 302 and the optical transmission device 100 and does not have a special function.

Accordingly, even if the subscriber device 300 is one core or two cores, an operation of connecting the optical transmission device 100 and the subscriber device 300 is an operation of connecting the accommodation module 200 to the optical transmission device 100 and connecting an optical fiber from the subscriber device 300, and thus the operation is simplified. Further, since the accommodation module 200 is only connected to the optical transmission device 100, the amount of operation is reduced as compared with installation of a WDM filter and a fiber wiring operation at the work site.

Further, since the optical fiber from the subscriber device 300 is not directly connected to the optical transmission device 100, it is possible to prevent the operator from making a mistake in connecting the optical fiber to the optical transmission device 100 without passing through the accommodation module 200.

### Second Embodiment

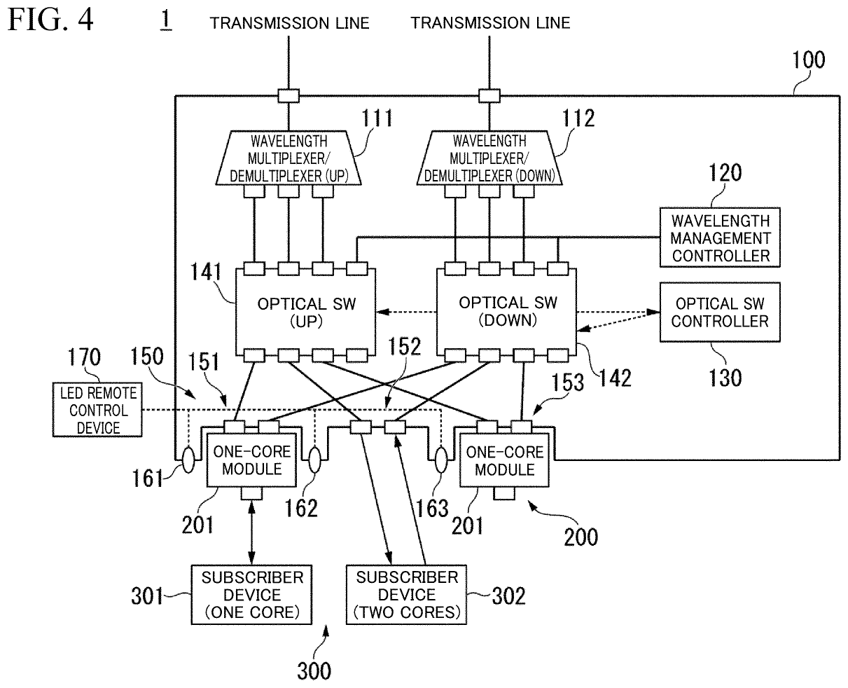

Next, a configuration example in which the connector 150 can directly connect an optical fiber without passing through the accommodation module 200 will be described. In the following, description of the already described reference numerals will be omitted. FIG. 4 is a block diagram illustrating a configuration of an optical transmission system 1 in a second embodiment.

The connector 150 can be connected with the one-core accommodation module 201, and can be directly connected with an optical fiber. As illustrated in FIG. 4, an optical fiber from the two-core subscriber device 302 is directly connected to the connector 152.

According to the second embodiment, there is a difference in whether or not the accommodation module 200 is connected, but installation of a WDM filter and a fiber wiring operation at the work site are not required as compared with the conventional technology. In addition, since all operations of connecting optical fibers and the accommodation module 200 are performed in front of the housing of the optical transmission device 100, the operation can also be simplified in the second embodiment.

### Third Embodiment

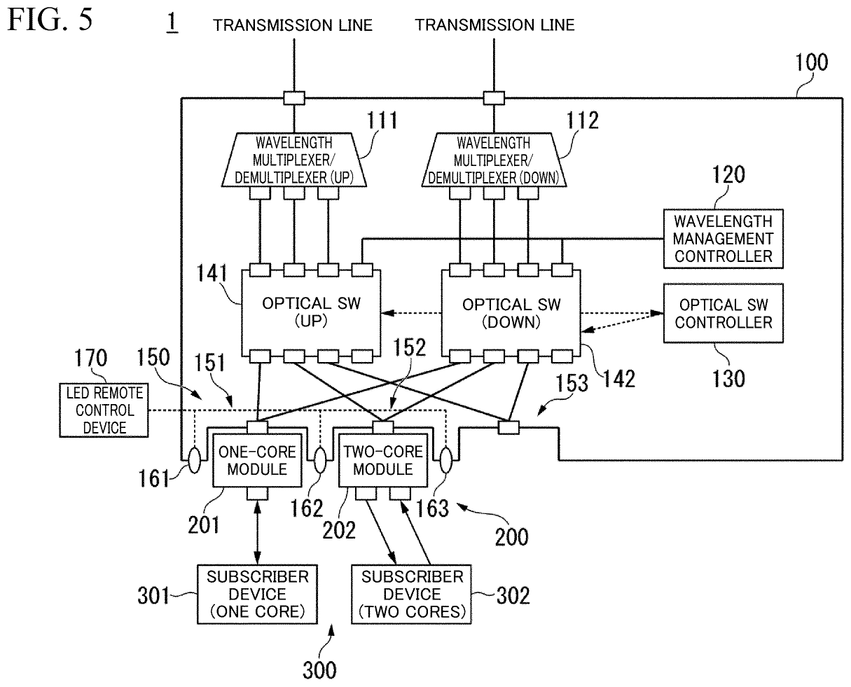

Next, a configuration example in which the connector 150 is connected to the accommodation module 200 through one port will be described. In the following, description of the already described reference numerals will be omitted. FIG. 5 is a block diagram illustrating a configuration of an optical transmission system 1 in a third embodiment.

Although the connector 150 is connected to the accommodation module 200 through two ports in the first and second embodiments, the connector 150 is connected to the accommodation module 200 through one port in the third embodiment, as illustrated in FIG. 5. Then, two optical fibers pass through the optical SWs 141 and 142 from one port. The configuration of the accommodation module 200 in this case will be described.

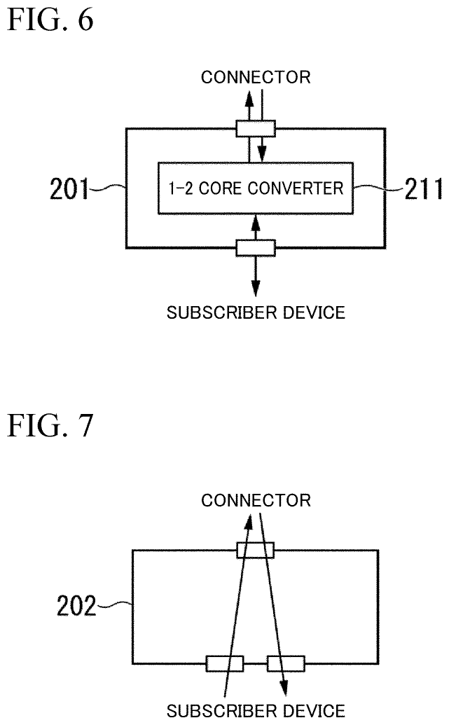

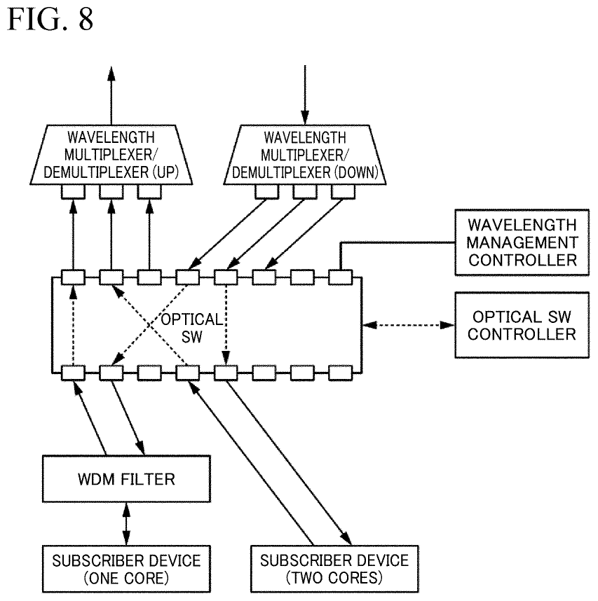

FIG. 6 is a diagram illustrating a configuration example of the one-core accommodation module 201. The one-core accommodation module 201 includes a 1-2 core converter 211. The 1-2 core converter 211 performs conversion from one core to two cores and from two cores to one core. The 1-2 core converter 211 is, for example, a WDM filter or a circulator. FIG. 7 is a diagram illustrating a configuration example of the two-core accommodation module 202. The two-core accommodation module 202 is simply a coupling part between the optical fiber from the subscriber device 302 and the optical transmission device 100 and does not have a special function.

Accordingly, even if the subscriber device 300 is one core or two cores, an operation of connecting the optical transmission device 100 and the subscriber device 300 is an operation of connecting the accommodation module 200 to the optical transmission device 100 and connecting an optical fiber from the subscriber device 300, and thus the operation is simplified. Further, since the accommodation module 200 is only connected to the optical transmission device 100, the amount of operation is reduced compared with installation of a WDM filter and a fiber wiring operation at the work site.

Further, since the number of ports to be prepared in the optical transmission device 100 can be reduced by connecting the connector 150 through one port, the housing size of the optical transmission device 100 can be reduced as compared with the case of two ports. In addition, the number of components of the optical transmission device 100 can be reduced as compared with the case of two ports, and the manufacturing man-hour can be reduced, and thus the cost of the optical transmission device 100 can be decreased.

Further, since the optical fiber from the subscriber device 300 is not directly connected to the optical transmission device 100 in the third embodiment, it is possible to prevent the operator from making a mistake in connecting the optical fiber to the optical transmission device 100 without passing through the accommodation module 200.

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention is applicable to an optical transmission device that performs transmission through an optical fiber transmission line.

### REFERENCE SIGNS LIST

1 Optical transmission system
100 Optical transmission device
111 Wavelength multiplexer/demultiplexer
111, 112 Up wavelength multiplexer/demultiplexer
120 Wavelength management controller
130 Optical SW controller
150, 151, 152, 153 Connector
200 Accommodation module
201 One-core accommodation module
202 Two-core accommodation module
211 1-2 core converter
300, 301, 302 Subscriber device

1. An optical transmission device comprising:
a connector that is able to be connected to an accommodation module accommodating an optical fiber such that optical communication is performed;
an optical switch that receives an optical signal from the connector and outputs an optical signal to the connector;
an optical switch controller that controls the optical switch;
an up wavelength multiplexer/demultiplexer that multiplexes light of a plurality of wavelengths output from the optical switch and outputs the multiplexed light to a transmission line; and
a down wavelength multiplexer/demultiplexer that demultiplexes light input from the transmission line and outputs the demultiplexed light to the optical switch,
wherein
the connector is able to be connected to any one of a one-core accommodation module and a two-core accommodation module as the accommodation module.

2. The optical transmission device according to claim 1, wherein the connector is able to directly connect an optical fiber without passing through the accommodation module.

3. The optical transmission device according to claim 1, wherein the connector is connected to the accommodation module through one port.

4. The optical transmission device according to claim 1, further comprising a wavelength management controller that dynamically allocates a wavelength to be used by a communication destination connected via the accommodation module.

5. The optical transmission device according to claim 1, comprising a plurality of connectors; and
an identification part that is able to identify the connector to which the accommodation module connecting an optical fiber is connected, among the plurality of connectors.

6. The optical transmission device according to claim 5,
wherein the identification part is an LED lamp, and a state of the LED lamp is remotely controllable.

7. An optical transmission device comprising:
a connector that is able to be connected to an accommodation module accommodating an optical fiber such that optical communication is performed;
an optical switch that receives an optical signal from the connector and outputs an optical signal to the connector;
an up wavelength multiplexer/demultiplexer that multiplexes light of a plurality of wavelengths output from the optical switch and outputs the multiplexed light to a transmission line; and
a down wavelength multiplexer/demultiplexer that demultiplexes light input from the transmission line and outputs the demultiplexed light to the optical switch,
wherein
the connector is able to be connected to any one of a one-core accommodation module and a two-core accommodation module as the accommodation module.
